(19) United States
(12) Patent Application Publication
(10) Pub. No.: US 2025/0315488 A1
(43) Pub. Date: Oct. 9, 2025

(54) METHOD FOR RETRIEVAL-AUGMENTED GENERATION INTERACTING WITH GENERATIVE ARTIFICIAL INTELLIGENCE AND APPARATUS THEREFOR

(71) Applicant: SAMSUNG SDS CO., LTD., Seoul (KR)

(72) Inventors: Seungmin BAEK, Seoul (KR); Tae Hwang YOO, Seoul (KR)

(73) Assignee: SAMSUNG SDS CO., LTD., Seoul (KR)

(21) Appl. No.: 19/169,611

(22) Filed: Apr. 3, 2025

(30) Foreign Application Priority Data
Apr. 3, 2024 (KR) 10-2024-0045453
May 23, 2024 (KR) 10-2024-0067366

(51) Int. Cl. G06F 16/93; G06F 16/901; G06F 16/906; G06F 16/953

(52) U.S. Cl. CPC G06F 16/93; G06F 16/901; G06F 16/906; G06F 16/953

(57) ABSTRACT

A processor-implemented method including separating a first document into a second document, the second document including a first metadata portion of first metadata of the first document, and a third document, the third document including a first content portion of content of the first document, classifying the second document and the third document into a first material set and a second material set, respectively, and indexing the second document and the third document according to a correlation of the second document and the third document.

### CROSS-REFERENCE TO RELATED APPLICATION(S)

This application claims the benefit under 35 USC § 119 (a) of Korean Patent Applications No. 10-2024-0045453, filed on Apr. 3, 2024 and No. 10-2024-0067366, filed on May 23, 2024, in the Korean Intellectual Property Office, the entire disclosures of which are incorporated herein by reference for all purposes.

### BACKGROUND

### 1. Field

The present disclosure is intended to optimize the output of a generative artificial intelligence (AI) (hereinafter referred to as “GenAI”) such as a large language model (hereinafter referred to as “LLM”) and improve the accuracy of its response and, more specifically, relates to an improved retrieval-augmented generation (hereinafter referred to as “RAG”) method interacting with generative AI, and an apparatus therefor.

### 2. Description of the Related Art

Fine-adjusting a language model itself using inside data held by companies to utilize GenAI generally requires a lot of resources and effort, and it is difficult to efficiently update the parameters of a model pre-trained based on a large amount of data.

Therefore, for example, the RAG architecture is being used importantly, such as retrieving content semantically similar to the user input query from the internal vector database and transmitting the same to the LLM as the context of the user query. Here, RAG comprehensively indicates the process of optimizing the output of GenAI such as an LLM so as to refer to a reliable knowledge database outside the learning data source before generating a response.

Recently, the utilization of AI through a copilot interface has been spreading, and various copilot solutions for individuals or companies are being developed, and a RAG framework is being configured to provide data such as emails, files, conversations, and meeting transcripts, which are stored in the solution, as the context of the LLM.

In order to improve the efficiency of a vector search system that is the basis of RAG, a large amount of data must be vectorized, so a method is needed to reduce the total maintenance cost while increasing the stability of the service and search performance in an environment where a large amount of content must be indexed and retrieved.

Compared to the existing keyword matching-based search system, the vector search system incurs additional storage and memory overhead due to vectorization, and a more improved approach is needed to improve search quality through efficient grafting into the RAG solution.

Therefore, a proposal for a new data storage structure and search request processing method in consideration of the characteristics of the vector search system is urgently needed.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, here is provided a processor-implemented method including separating a first document into a second document, the second document including a first metadata portion of first metadata of the first document, and a third document, the third document including a first content portion of content of the first document, classifying the second document and the third document into a first material set and a second material set, respectively, and indexing the second document and the third document according to a correlation of the second document and the third document.

The indexing may include indexing the second document and the third document according to a parent-child relationship.

The indexing may include assigning, to the third document, a field indicating a parent-child relationship of the third document with the second document.

The method may include upon receiving an update request for the first document, determining whether the update request is related to the first metadata and selectively performing an update only for the second document responsive to the determining indicating the update request is related to the first metadata.

The method may include performing filtering based on the first metadata and searching for documents belonging to the second material set, based on a single search index included in a single search query.

In a general aspect, here is provided a processor-implemented method including separating a first document into a second document and a third document, the second document including a first metadata portion of the first document and the third document including a first content portion of content of the first document, disposing an embedding vector based on the second document and an embedding vector based on the third document in a same field, and indexing the second document and the third document according to a correlation of the second document and the third document.

The first metadata portion may include a title of the first document.

The indexing may include assigning a field indicating a sequence to the second document and the third document.

The method may include returning the third document responsive to the second document being included in a search result for a search query.

In a general aspect, here is provided a processor-implemented method including determining respective types of a language of each chunk of a plurality of chunks extracted from a plurality of documents and assigning a language code indicating a respective type of the language for the each chuck in a language field, indexing the plurality of chunks to identify from which document, among the plurality of documents, each respective chunk is extracted from, receiving a search query in a first language and deriving a search query in the first language to expand the search query to one or more other languages among the determined respective types of languages through a large language model (LLM), and performing a search, based on the expanded search query.

The expanded search query may include one or more language codes and a query in a language corresponding to each of the language codes.

The search may include one of a keyword-based search, a vector-based search, or a hybrid search.

In a general aspect, here is provided a processor-implemented method including interacting with one or more search engines for a retrieval-augmented generation (RAG), inputting a query into a large language model (LLM) to receive an augmented query corresponding to the query depending on characteristics of the search engine, and inputting the augmented query into the search engine to request a search.

In a first case that the search engine is a keyword search-based search engine and in a second case that the query is in a sentence form, the augmented query may include one or more words included in the sentence and respective weights of the one or more words.

In a first case that the search engine is a vector similarity-based search engine and in a second case that the query is in a form of one or more keywords, the augmented query may include a sentence form including the one or more keywords.

The method may include performing a first search, based on the query and determining whether to receive the augmented query, based on a result of the first search.

The determining may be performed based on one of statistics or learning based on search history data including feedback on search results.

In a general aspect, here is provided an apparatus including a processor configured to execute instructions, a memory storing the instructions, and an execution of the instructions configures the processor to separate a first document into a second document and a third document, the second document including a first metadata portion of the first document and the third document including a first content portion of content of the first document, classify the second document and the third document into a first material set and a second material set, respectively, and index the second document and the third document according to a correlation of the second document and the third document.

In a general aspect, here is provided an apparatus including a processor configured to execute instructions, a memory storing the instructions, and an execution of the instructions configures the processor to separate a first document into a second document and a third document, the second document including a first metadata portion of the first document and the third document including a first content portion of content of the first document, dispose an embedding vector based on the second document and an embedding vector based on the third document in a same field, and index the second document and the third document according to a correlation of the second document and the third document.

In a general aspect, here is provided an apparatus including a processor configured to execute instructions, a memory storing the instructions, and an execution of the instructions configures the processor to determine respective types of a language of each chunk of a plurality of chunks extracted from a plurality of documents and assigning a language code indicating a respective type of the language for each chunk in a language field, index the plurality of chunks to identify from which document, among the plurality of documents, the each chunk is extracted from, receive a search query in a first language and deriving a search query in the first language to expand the search query, as an expanded search query, one or more other languages among the determined respective types of languages through a large language model (LLM), and perform a search, based on the expanded search query.

In a general aspect, here is provided an apparatus including a processor configured to execute instructions, a memory storing the instructions, and execution of the instructions configures the processor to interact with one or more search engines for a retrieval-augmented generation (RAG), input a query into a large language model (LLM) to receive an augmented query corresponding to the query depending on characteristics of the search engine, and input the augmented query into the search engine to request a search.

### BRIEF DESCRIPTION OF THE DRAWINGS

FIG. 1 illustrates an example of a data storage schema to which document separation and relationship configuration are applied in consideration of update frequency and index load.

FIG. 2 illustrates an example of a search query using the data storage having the schema illustrated above.

FIG. 3 illustrates an example of a data storage schema that stores embedding values of metadata (title, etc.) and embedding values of content separately in the same column (field).

FIG. 4 illustrates an example of a data storage schema for searching through content language identification and language-specific query augmentation.

FIG. 5 illustrates an example of a prompt 160 for transmitting a user's query to an LLM and converting the query into a scheme specialized for keyword search and a response 170 through the LLM.

FIG. 6 illustrates an example of a prompt 180 for transmitting a user's query to an LIM and converting the query into a scheme specialized for vector search and a response 190 through the LLM.

FIG. 7 illustrates a search history management database for RAG.

FIG. 8 illustrates a RAG architecture for utilizing an LLM.

FIG. 9 illustrates a function execution flow performed in a RAG search system 100.

FIG. 10 illustrates an apparatus 120 to which the proposed method of the present disclosure may be applied.

Throughout the drawings and the detailed description, unless otherwise described or provided, the same, or like, drawing reference numerals may be understood to refer to the same, or like, elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Advantages and features of the present disclosure and methods of achieving the advantages and features will be clear with reference to embodiments described in detail below together with the accompanying drawings. However, the present disclosure is not limited to the embodiments disclosed herein but will be implemented in various forms.

The embodiments of the present disclosure are provided so that the present disclosure is completely disclosed, and a person with ordinary skill in the art can fully understand the scope of the present disclosure. The present disclosure will be defined only by the scope of the appended claims. Meanwhile, the terms used in the present specification are for explaining the embodiments, not for limiting the present disclosure.

Terms, such as first, second, A, B, (a), (b) or the like, may be used herein to describe components. Each of these terminologies is not used to define an essence, order or sequence of a corresponding component but used merely to distinguish the corresponding component from other component(s). For example, a first component may be referred to as a second component, and similarly the second component may also be referred to as the first component.

Throughout the specification, when a component is described as being “connected to,” or “coupled to” another component, it may be directly “connected to,” or “coupled to” the other component, or there may be one or more other components intervening therebetween. In contrast, when an element is described as being “directly connected to,” or “directly coupled to” another element, there can be no other elements intervening therebetween.

In a description of the embodiment, in a case in which any one element is described as being formed on or under another element, such a description includes both a case in which the two elements are formed in direct contact with each other and a case in which the two elements are in indirect contact with each other with one or more other elements interposed between the two elements. In addition, when one element is described as being formed on or under another element, such a description may include a case in which the one element is formed at an upper side or a lower side with respect to another element.

The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

### Proposed Method of the Present Disclosure

### Document Separation and Relationship Configuration Considering Update Frequency and Index Load

For vectorizing, storing, and searching for text, vector search systems for RAG generally use a method of storing and searching both content data including vectors and metadata of content. However, since content data is relatively large in size and requires separate analysis for search, adding and modifying data incurs a relatively large cost.

In addition, since a graph configuration step may be added to the vector search system to apply embedding and approximate nearest neighbors (hereinafter “ANN”) search, the indexing cost becomes greater than that of general search systems, and when metadata and content data are stored in the same document as in the past, a large overhead occurs due to relatively frequent metadata updates, which adversely affects the efficiency of the entire search system.

Therefore, in this embodiment, data is separated from the original document in terms of update frequency and index load, thereby separately configuring search target documents and configuring the relationship among the documents, and then the search is performed. In addition, data is structured in a parent-child relationship so that a search is able to be performed with a single search query.

This configuration is based on the fact that the update frequency and index load differ among detailed fields that constitute a single search target document. For example, data sets are separated according to the update frequency and/or index load, and relationships among data sets are configured inside the data storage, enabling vector searching by a single search query with filtering using authority information or the like.

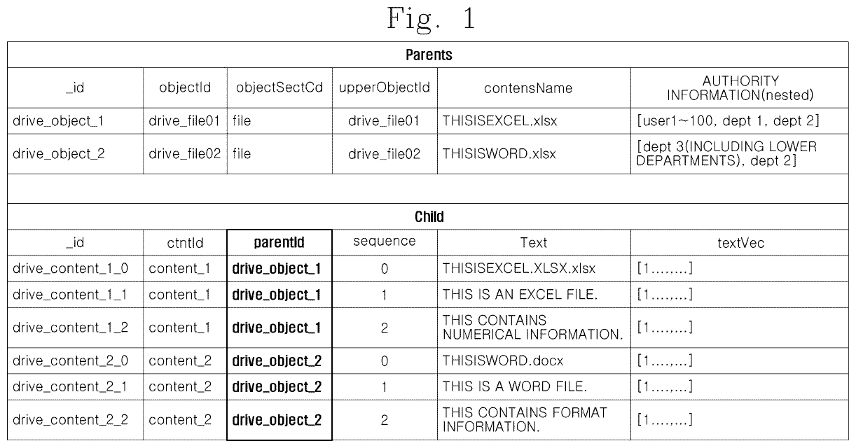

FIG. 1 illustrates an example of a data storage schema to which document separation and relationship configuration are applied in consideration of update frequency and index load.

The illustrated data storage includes a data set called “Parents” and a data set called “Child”. Here, the “Parents” set has the characteristics of having the possibility of large batch updates, high individual update frequency, and low index load. On the other hand, the “Child” set has the characteristics of having updates at the time of events by specific users and high index load.

As illustrated in FIG. 1, metadata (“authority information” in this example) is separated from an original document with the title (file name, etc.) of “ThisisExcel.xlsx” and stored as one document in the Parents set, and other information (chunks separated from the document title “ThisisExcel.xlsx” and the content of the document in this example) is stored as separate documents in the Child set.

In addition, the top three documents stored in the Child set are indexed as “drive_content 1_0”,“drive_content_1_1”, and “drive_content_1_2”, respectively, in the “_id” field, and “drive_content_1”, which is the value of the “_id” field of the document in the Parents set related to these documents, is recorded in a separate “parentId” field. Based on this data structure, relationships among the documents and parent-child relationships may be identified from the “parentId” field or “_id” field.

In the case of managing documents separately as described above, for example, when metadata such as authority information needs to be updated, only the documents in the Parents set are affected, and at this time, content data, which is stored in the Child set and has a large data size and requires a lot of costs in re-indexing, remains, thereby increasing the efficiency of data management.

In addition, by representing the parent-child relationship with a single search index in the document index, filtering through the data of the parent documents and searching for the data of the child documents are possible with a single search query as described below.

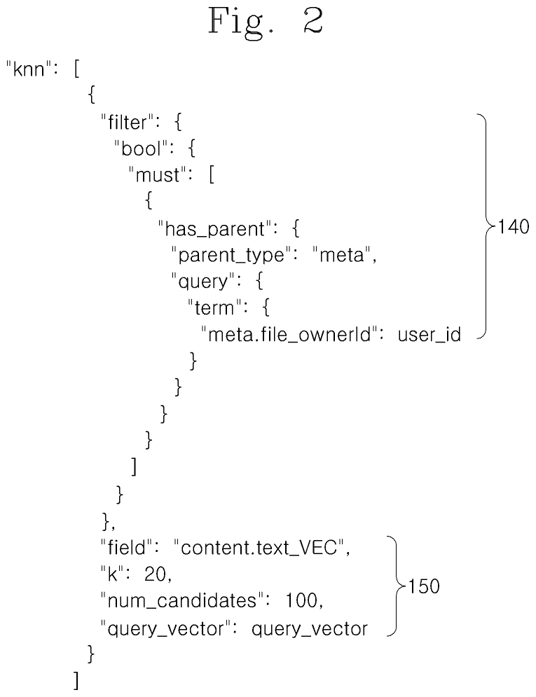

FIG. 2 illustrates an example of a search query using the data storage having the schema illustrated above.

As shown in the example, if there is a document in the Parents set, which has a parent-child relationship with a search target document of the Child set, filtering 140 based on the user ID (user_id) restricted by the metadata is possible by enquiring metadata (authority information restricting the user or department accessible to data in the example) recorded in the document of the Parents set with a single query including the user ID (user_id) data.

As a result, a search may be performed within the range of documents that the corresponding user has an authority to access, among the documents of the Child set, and the result may be returned as a response. This document indexing and searching method is particularly significant in the case of RAG solutions targeting enterprises because it is easy to reflect authority information that is configured differently among user, departments, projects, and the like.

### Metadata (Title, etc.) Embedding Values and Content Embedding Values are Separated and Stored in the Same Column

When performing vectorization of documents, not only the content but also the metadata such as a title may be utilized as important information for vector search. In particular, in enterprise search systems, the title of content often contains the subject and important information of the content. Therefore, in order to utilize the title for search, an approach may be considered in which the content and title are respectively vectorized and stored in different fields, and in which the weights are adjusted to compare the user input query with the vectorized result. However, this has the problem in which the overhead due to the vectorization process doubles.

In order to reduce this overhead, a method may be considered in which the metadata requiring vectorization is considered a type of special token, and in which the title and content are combined in one field to vectorize them. However, there is a disadvantage in that the meaning of the vector as a result of the embedding becomes unclear, and in particular, in the case of content with a title unrelated to the content, it may act as a factor in lowering the search quality.

Therefore, this embodiment proposes a method of embedding metadata including the title that require vectorization and content, respectively, and then storing them in the same column (or field), thereby preventing multiple pieces of vector data from being included in a single document. In addition, values (e.g., title, content 1, content 2, and the like) capable of distinguish between the types of embedding vectors may be stored as separate fields, and if a title vector is searched for as a result of a similarity search, the content related thereto may be included in the search result and transmitted.

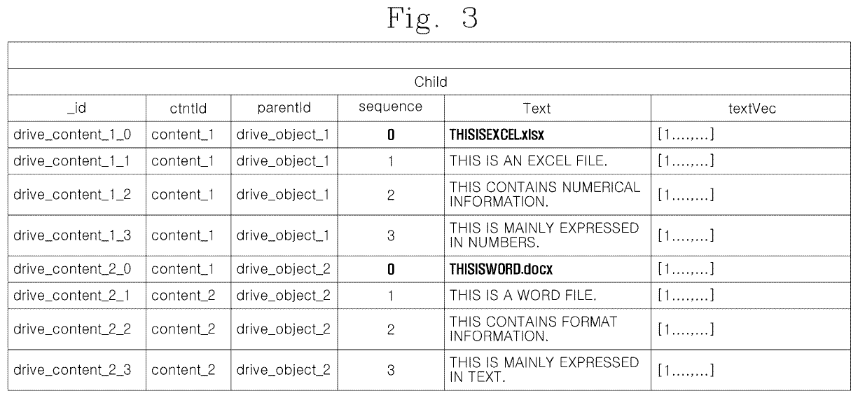

FIG. 3 illustrates an example of a data storage schema that stores embedding values of metadata (title, etc.) and embedding values of content separately in the same column (field).

As illustrated, the embedding results for metadata that contain items of the content, such as the title of the content, and the embedding results for the content may be assigned to the same column (field) and stored in different rows, and a distinction value may be added to each row, so that the search results may be processed and configured differently according to the distinction values of the items included in the vector search result and then returned. Accordingly, it is possible to minimize the overhead according to addition of multiple vector fields, thereby expanding the vector search target.

For example, in FIG. 3, when the sequence field value for each document in the Child set is 0, the text of title is stored in the Child.Text field, and a vector value obtained by embedding the text of title is stored in the Child.textVec field. Accordingly, the title is configured as a separate vector field while maintaining the vector for the title as a search target, so the storage and memory overhead may be reduced, compared to a data structure where the title is added to every rows.

Here, in terms of the RAG performance, it is often desirable to return data about chunks, rather than data about title text, as a response, so if a search result (top k) includes a vector for the title (i.e., if the search result includes a document in a row whose sequence field value is 0 in FIG. 3), the vector for related chunks (i.e., documents of other rows whose ctnId field values are the same and whose sequence field values are 1 or greater in FIG. 3) may be match-searched for, based on the content ID, and then the chunk with the highest similarity may be selected and its vector may be returned as a response.

In the example above, if the search result (top k) includes a vector for “ThisisExcel.xlsx” whose _id field value is drive_content_1_0, a similarity search is performed on chunks whose sequence field values are 1 or greater, among the data whose ctntId field value is content 1, and the chunk with the highest similarity is selected.

### Search Through Content Language Identification and Language-Specific Query Augmentation

Even in the case where the language model for generating the embedding vector supports multilingual processing, if embedding and searching are performed in the state where the language differs between the query and the content, the similarity of the result vector tends to be low. For example, in the case where the Korean content “ [symbol] ” is embedded, the similarity becomes higher when the Korean word “ [symbol] ”, rather than the English word “test”, is embedded in the query to compare the similarity.

Therefore, this embodiment proposes a configuration of identifying the language of the content when the content is stored and storing the identified language code, as metadata of the content, together with the content.

At the time of searching, the search word entered by the user may be augmented into various languages through LLMs, and both the language code of the search word and the search word may be transmitted together to the search system for searching. At this time, a similarity search may be performed by utilizing the search word corresponding to the language code of the content, or a weight search may be performed by including the matching or non-matching language code in the scoring criteria.

As described above, unlike the general search word augmentation method through LLMs, it is possible to more effectively implement RAG considering multilingual processing by identifying the language of the search target content, storing it at the time of indexing, and including it in the search conditions for utilization.

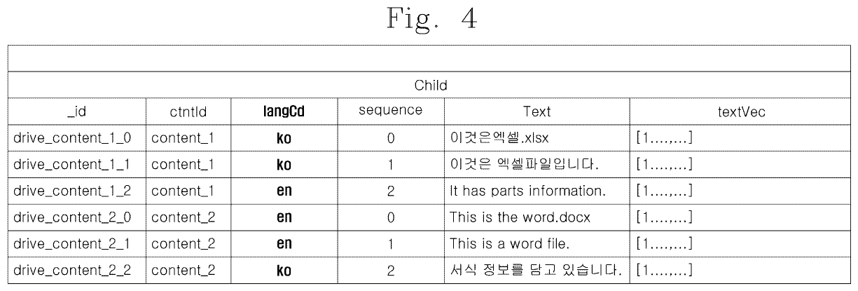

FIG. 4 illustrates an example of a data storage schema for searching through content language identification and language-specific query augmentation.

As illustrated in FIG. 4, the language of each chunk is determined at the time of indexing and stored in the langCd field indicating the language code. Even if the chunks are extracted from the same content (i.e., the ctntId field values are the same), each chunk may have various language codes such as ko or en.

As described above, even if the embedding model supports multiple languages, there may be differences in similarity during searching depending on whether or not they are the same language, so the above data structure may be usefully utilized when searching vectors based on KNN (K-Nearest Neighbor). In addition, this data structure may improve the search performance according to language matching in keyword searches based on BM25, etc., and may also improve the search performance in hybrid searches in which both vector searches such as KNN and keyword searches such as BM25 are applied.

For example, in the case where the language code is identified and indexed for each chunk and where the user query is expanded by language to search as in FIG. 4, the following process may be followed.
1. The user queries (Query example: “ [symbol] ”).
2. Query expansion using LIMs (within the range of a language list supported by the system): Example of LLM response {“ko”: “ [symbol] ” and “en”: “Find partial information”}.
3. Both the language code and the query statement are configured as query conditions to perform KNN search and BM25 search (hybrid search).
4. The top k results are returned as a response.

### Query Expansion Using LLMs in Situations Such as Hybrid Search

In addition, hybrid search that mixes BM25-based keyword search and vector search results is often used in vector search, but when two searches with different characteristics are performed based on the same search query, the search quality may differ depending on the user's query method, which may cause a deviation in search accuracy that is difficult for the user to recognize.

To improve this problem, this embodiment proposes a method of performing a search by augmenting the user input query into a query appropriate for BM25 and vector searches using LLM. That is, in the case where the user query is transmitted and used as it is for both the vector search and the BM25 search, a deviation in search accuracy may occur depending on the characteristics of the query entered by the user. Therefore, it may be transformed and processed into a query more appropriate for BM25 and vector searches using an LLM, thereby improving the accuracy.

For example, considering the characteristics of BM25-based keyword search, assuming that a user query is “Find documents related to the schedule of Project A”, if the query is directly entered into BM25-based keyword search, the words such as “related” and “Find” are also included in the search conditions so that searching is performed with the same weight, so documents unrelated to Project A will be highly likely to be selected.

At this time, the user query may be transmitted to the LIM, so that the query may be converted into a scheme specialized for keyword search, for example, through the following prompt. In the case of keyword-based search, search may be expanded to and utilize weight information according to the importance of each keyword.

### User Input: Find Documents Related to the Schedule of Project A

Query expansion for keyword search: {“Project A”: 0.5, “schedule”: 0.3, “document”: 0.2}

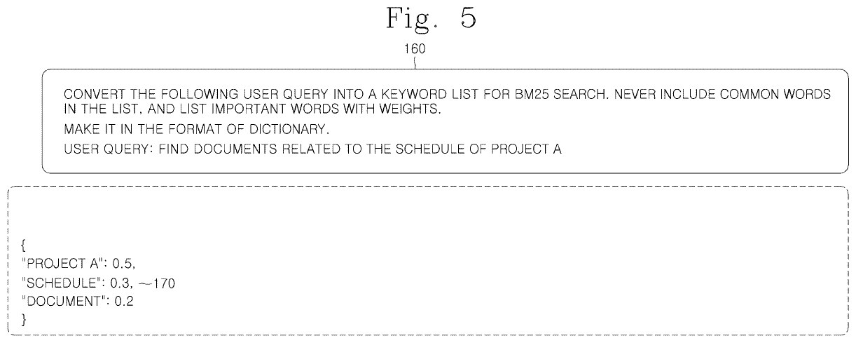

FIG. 5 illustrates an example of a prompt 160 for transmitting a user query to an LLM and converting the query into a scheme specialized for keyword search and a response 170 through the LLM.

Meanwhile, due to the characteristics of vector search, it often increases the accuracy when performing searching by embedding a query in a sentence form rather than simply listing keywords depending on the characteristics of the embedding model used. For example, the following prompt may be used to expand the user query into a form favorable for vector search.

### User Input: Schedule of Project A

Query expansion result for vector search: Tell me about the schedule related to Project A

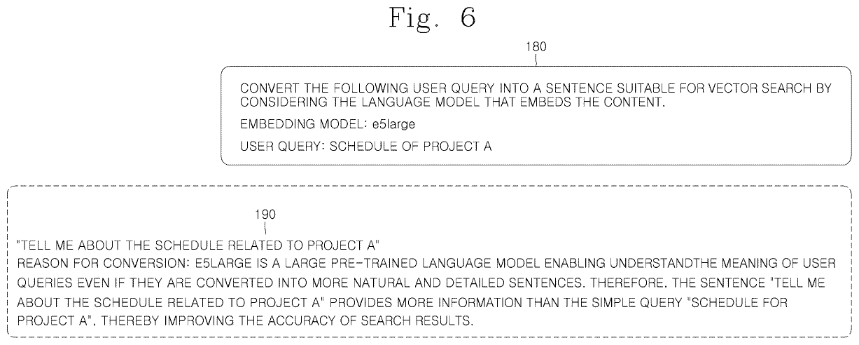

FIG. 6 illustrates an example of a prompt 180 for transmitting a user query to an LLM and converting the query into a scheme specialized for vector search and a response 190 through the LLM.

As described above, the user query may expand through the LLM in hybrid search to generate and utilize a query statement suitable for the characteristics of different search methods such as keyword search, vector similarity search, and the like, thereby reducing the deviation in search accuracy depending on user input.

### Determination of Search Query Augmentation Through Search Score Management

When attempting to improve search quality using a search query augmentation method utilizing an LLM in vector search, it takes much time to call the LLM, which may lead to an increase in search response time, causing a problem. To solve this problem, this embodiment proposes a module of configuring a module to determine whether or not search word augmentation needs to be performed and determining whether or not to perform search word augmentation through the LLM, based on the determination result.

As described above, it is possible to shorten the time required for searching by selectively applying search word augmentation, and furthermore, to improve usability by providing user feedback on whether or not the search word augmentation is applied.

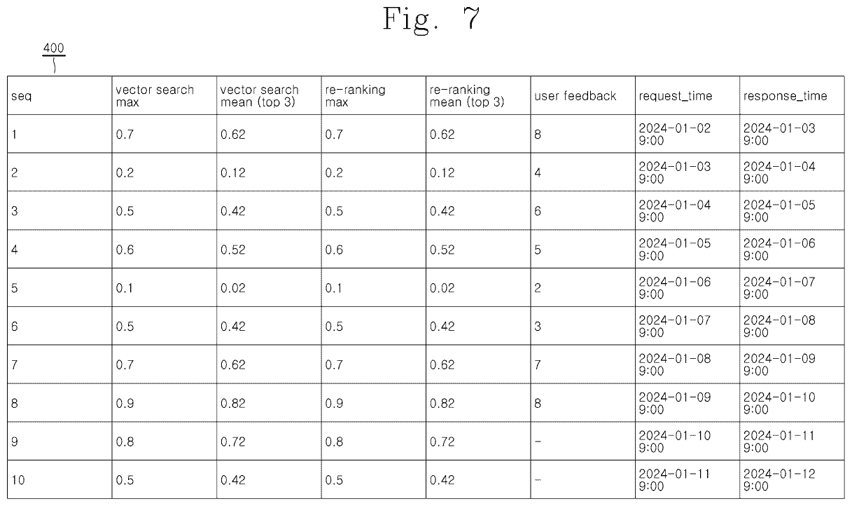

FIG. 7 illustrates a search history management database for RAG.

A search score management module constructs and manages a search history management database for RAG in the form illustrated in FIG. 7. Here, the search scores (the vector search max, the vector search mean, the re-ranking max, the re-ranking mean field, etc. illustrated in FIG. 7) may be stored at the time at which the search result is provided, and the user feedback (the user feedback field, etc. illustrated in FIG. 7) may be stored at the time at which the user feedback on the related search result is registered.

The search score management module may manage a threshold that is a reference for determining whether or not to augment search words, based on data stored in the database described above, or train a model that predicts user feedback, based on the scores, so as to serve.

Here, the threshold value may be managed based on statistics (e.g., 50% section based on percentile).

In addition, the prediction of user feedback may utilize a model that performs data learning (e.g., based on regression) with user feedback as Y and various search scores as X, and inputs (feeds) the scores of the first search (or initial search) results into the trained model to predict user feedback.

When the search score management module is constructed in this way, the search module may utilize it to determine whether or not to augment the search word.

The search module may determine whether or not to perform an advanced retrieval at the time of performing the first retrieval (or initial retrieval) from the inside data.

If it is determined that augmentation of the search word is necessary, the search module performs re-searching and re-ranking through the augmented search word using internal/external LLMs, and then returns the final search results.

As a result of the first retrieval, if multiple pieces of content with scores higher than a reference value are included and if the score deviation is not large, the first search result is transmitted as it is.

### RAG Architecture and Function Execution Flow for LLM Utilization

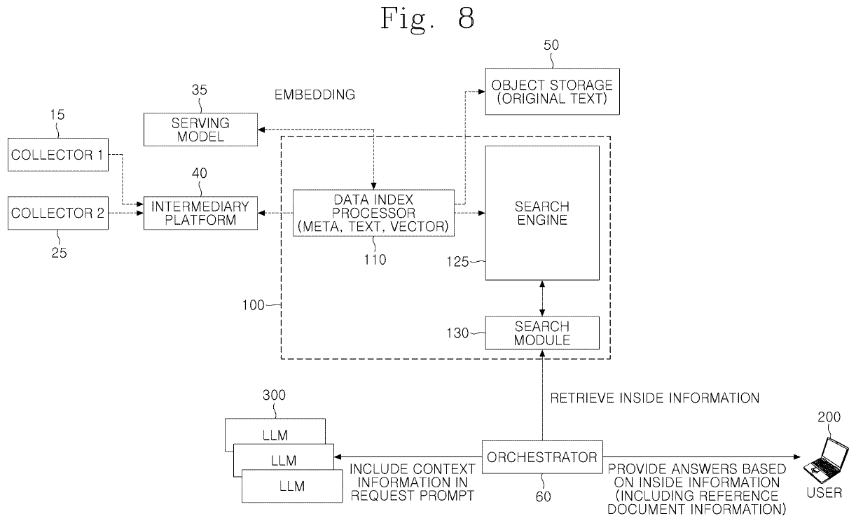

FIG. 8 illustrates a RAG architecture for utilizing an LLM.

A RAG search system 100 includes a data index processor 110, a search engine 125, and a search module 130. The data index processor 110 receives various documents, content, and the like collected by collector 1 (15), collector 2 (25), and the like through an intermediary platform 40 (e.g., Kafka or the like).

The data index processor 110 processes the input documents and content, performs embedding in conjunction with a serving model 35, and stores the original text of the documents and content in the object storage 50.

The RAG search system 100 interacts with an LLM 300 through an orchestrator 60 and is connected to a user terminal 200. When the user terminal inputs a query, the RAG process interacting with the LIM 300 is performed through the search module 130 and the search engine 125.

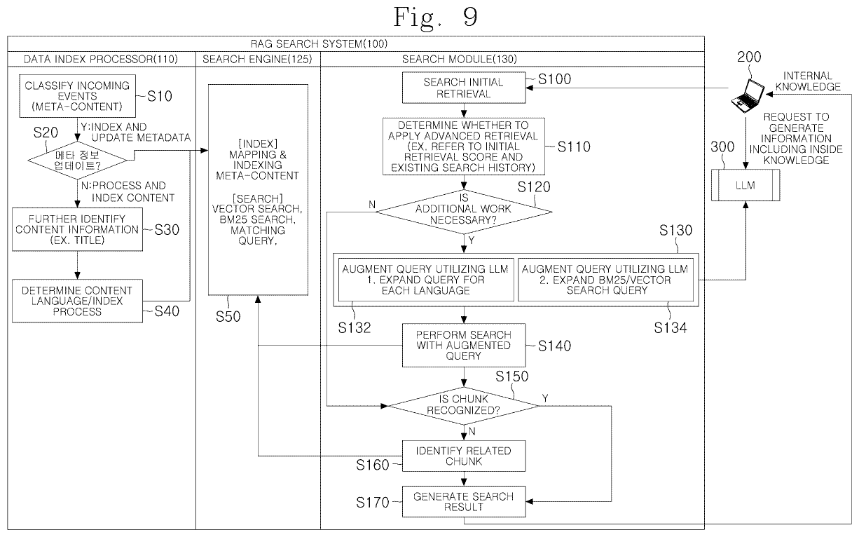

FIG. 9 illustrates a function execution flow performed in a RAG search system 100.

The data index processor 110 classifies incoming events for content and documents and extracts metadata and content data (S10). The data index processor 110 determines whether the incoming event is an index and update event for metadata (S20) and, if so, requests the search engine 125 to update metadata in the database (S50). If the incoming event is not an indexing and update event for metadata, the data index processor 110 determines it to be a processing and indexing event for content, and further identifies the title and the like of the content data (S30), generates a language reading and indexing request for each content chunk (S40), and performs an update of the corresponding item in the database through the search engine (S50).

The search module 130 performs an initial retrieval when a search query is received from the user terminal 200 (S100), and determines whether or not to apply search word augmentation (or deepened search) by utilizing the search score management module (referring to the initial search score, existing search history, etc.) described above (S110). Accordingly, the search module 130 determines whether or not additional work such as language-specific query expansion or query expansion for BM25/vector search is necessary (S120) and performs an appropriate query augmentation work using an LIM according to the determination result (S130). The search module 130 performs searching through the search engine 125, based on the augmented query (S140), determines whether or not the search result relates to a chunk (S150), identifies the related chunk if it does not relate to the chunk (e.g., title, etc.) (S160), and generates the final search result (S170).

The generated search result is included in the request prompt as context information and is transmitted to the LLM 300 interacting with the RAG search system 100, thereby providing the user with an answer based on inside information.

### Apparatus to Which Proposed Method of the Present Disclosure is to be Applied

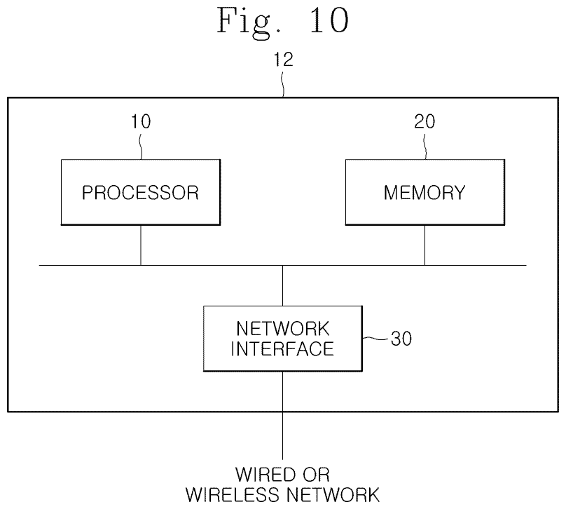

FIG. 10 illustrates an apparatus 120 to which the proposed method of the present disclosure may be applied.

Referring to FIG. 10, the apparatus 120 may be configured to implement a data structure construction process and/or a search process according to a method for retrieval-augmented generation (RAG) interacting with generative AI of the present disclosure. For example, the apparatus 120 may be a server device or a terminal device providing a RAG service.

For example, the apparatus 120 to which the proposed method of the present disclosure may be applied may include network devices such as repeaters, hubs, bridges, switches, routers, gateways, and the like, computer devices such as desktop computers, workstations, and the like, mobile terminals such as smartphones and the like, portable devices such as laptop computers and the like, home appliances such as digital TVs and the like, and moving means such as vehicles and the like. As another example, the apparatus 120 to which the present disclosure may be applied may be included as part of an ASIC (Application Specific Integrated Circuit) implemented in the form of an SoC (System-on-Chip).

The memory 20 may be connected to the processor 10 during operation, and may store programs and/or instructions for processing and controlling the processor 10, and may store data and information used in the present disclosure, control information required for processing data and information according to the present disclosure, and temporary data generated during the data and information processing process. The memory 20 may be implemented as a storage device such as a ROM (Read-Only Memory), a RAM (Random Access Memory), an EPROM (Erasable Programmable Read-Only Memory), an EEPROM (Electrically Erasable Programmable Read-Only Memory), a flash memory, a SRAM (Static RAM), an HDD (Hard Disk Drive), an SSD (Solid State Drive), and the like.

The processor 10 may be operatively connected to the memory 20 and/or the network interface 30, and may control the operation of respective modules in the apparatus 120. In particular, the processor 120 may perform various control functions for performing the proposed method of the present disclosure. The processor 120 may also be called a controller, a micro-controller, a micro-processor, a micro-computer, or the like. The proposed method of the present disclosure may be implemented by hardware, firmware, software, or a combination thereof. When implementing the present disclosure using hardware, an ASIC (application specific integrated circuit) or a DSP (digital signal processor), a DSPD (digital signal processing device), a PLD (programmable logic device), an FPGA (field programmable gate array), or the like, configured to perform the present disclosure, may be provided in the processor 10.

Meanwhile, when implementing the proposed method of the present disclosure using firmware or software, the firmware or software may include instructions related to modules, procedures, or functions that perform functions or operations necessary for implementing the proposed method of the present disclosure, and the instructions may be stored in the memory 20 or stored in a computer-readable recording medium (not shown) separate from the memory 20, and may be configured to cause, when executed by the processor 10, the apparatus 120 to perform the proposed method of the present disclosure.

In addition, the apparatus 120 may include a network interface device 30. The network interface device 30 may be connected to the processor 10 during operation, and the processor 10 may control the network interface device 30 to transmit or receive wireless/wired signals carrying information, data, signals, and/or messages through a wireless/wired network. The network interface device 30 may support various communication standards such as IEEE 802 series, 3GPP LTE (-A), 3GPP 5G, etc., and may transmit and receive control information and/or data signals according to the corresponding communication standards. The network interface device 30 may be implemented outside the apparatus 120 as needed.

Various embodiments of the present disclosure do not list all available combinations but are for describing a representative aspect of the present disclosure, and descriptions of various embodiments may be applied independently or may be applied through a combination of two or more.

A number of embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

### INDUSTRIAL APPLICABILITY

The present disclosure may be applied to various devices such as server devices, terminal devices, and network devices for retrieval-augmented generation (RAG) that interacts with generative AI.

What is claimed is:

1. A processor-implemented method, the method comprising:
separating a first document into a second document, the second document including a first metadata portion of first metadata of the first document, and a third document, the third document including a first content portion of content of the first document;
classifying the second document and the third document into a first material set and a second material set, respectively; and
indexing the second document and the third document according to a correlation of the second document and the third document.

2. The method of claim 1, wherein the indexing comprises:
indexing the second document and the third document according to a parent-child relationship.

3. The method of claim 1, wherein the indexing comprises:
assigning, to the third document, a field indicating a parent-child relationship of the third document with the second document.

4. The method of claim 1, further comprising:
upon receiving an update request for the first document, determining whether the update request is related to the first metadata; and
selectively performing an update only for the second document responsive to the determining indicating the update request is related to the first metadata.

5. The method of claim 1, further comprising:
performing filtering based on the first metadata; and
searching for documents belonging to the second material set, based on a single search index included in a single search query.

6. A processor-implemented method, the method comprising:
separating a first document into a second document and a third document, the second document including a first metadata portion of the first document and the third document including a first content portion of content of the first document;
disposing an embedding vector based on the second document and an embedding vector based on the third document in a same field; and
indexing the second document and the third document according to a correlation of the second document and the third document.

7. The method of claim 6, wherein the first metadata portion comprises a title of the first document.

8. The method of claim 6, wherein the indexing comprises:
assigning a field indicating a sequence to the second document and the third document.

9. The method of claim 6, further comprising:
returning the third document responsive to the second document being included in a search result for a search query.

10. A processor-implemented method, the method comprising:
determining respective types of a language of each chunk of a plurality of chunks extracted from a plurality of documents and assigning a language code indicating a respective type of the language for the each chuck in a language field;
indexing the plurality of chunks to identify from which document, among the plurality of documents, each respective chunk is extracted from;
receiving a search query in a first language and deriving a search query in the first language to expand the search query to one or more other languages among the determined respective types of languages through a large language model (LLM); and
performing a search, based on the expanded search query.

11. The method of claim 10, wherein the expanded search query comprises one or more language codes and a query in a language corresponding to each of the language codes.

12. The method of claim 10, wherein the search comprises one of a keyword-based search, a vector-based search, or a hybrid search.

13. A processor-implemented method, the method comprising:
interacting with one or more search engines for a retrieval-augmented generation (RAG);
inputting a query into a large language model (LLM) to receive an augmented query corresponding to the query depending on characteristics of the search engine; and
inputting the augmented query into the search engine to request a search.

14. The method of claim 13, wherein, in a first case that the search engine is a keyword search-based search engine and in a second case that the query is in a sentence form, the augmented query comprises one or more words included in the sentence and respective weights of the one or more words.

15. The method of claim 13, wherein, in a first case that the search engine is a vector similarity-based search engine and in a second case that the query is in a form of one or more keywords, the augmented query comprises a sentence form comprising the one or more keywords.

16. The method of claim 13, further comprising:
performing a first search, based on the query; and
determining whether to receive the augmented query, based on a result of the first search.

17. The method of claim 16, wherein the determining is performed based on one of statistics or learning based on search history data comprising feedback on search results.

18. An apparatus, comprising:
a processor configured to execute instructions; and
a memory storing the instructions, wherein execution of the instructions configures the processor to:
separate a first document into a second document and a third document, the second document including a first metadata portion of the first document and the third document including a first content portion of content of the first document;
classify the second document and the third document into a first material set and a second material set, respectively; and
index the second document and the third document according to a correlation of the second document and the third document.

19. An apparatus, comprising:
a processor configured to execute instructions; and
a memory storing the instructions, wherein execution of the instructions configures the processor to:
separate a first document into a second document and a third document, the second document including a first metadata portion of the first document and the third document including a first content portion of content of the first document;
dispose an embedding vector based on the second document and an embedding vector based on the third document in a same field; and
index the second document and the third document according to a correlation of the second document and the third document.

20. An apparatus, comprising:
a processor configured to execute instructions; and
a memory storing the instructions, wherein execution of the instructions configures the processor to:
determine respective types of a language of each chunk of a plurality of chunks extracted from a plurality of documents and assigning a language code indicating a respective type of the language for each chunk in a language field;
index the plurality of chunks to identify from which document, among the plurality of documents, the each chunk is extracted from;
receive a search query in a first language and deriving a search query in the first language to expand the search query, as an expanded search query, one or more other languages among the determined respective types of languages through a large language model (LLM); and
perform a search, based on the expanded search query.

21. An apparatus, comprising:
a processor configured to execute instructions; and
a memory storing the instructions, wherein execution of the instructions configures the processor to:
interact with one or more search engines for a retrieval-augmented generation (RAG);
input a query into a large language model (LLM) to receive an augmented query corresponding to the query depending on characteristics of the search engine; and
input the augmented query into the search engine to request a search.
